(19) United States
(12) Patent Application Publication
(10) Pub. No.: US 2020/0324581 A1
(43) Pub. Date: Oct. 15, 2020

(54) Pneumatic Tire

(71) Applicant: The Yokohama Rubber Co., LTD., Minato-ku, Tokyo (JP)

(72) Inventor: Ryohei Takemori, Hiratsuka-shi, Kanagawa (JP)

(21) Appl. No.: 16/304,666

(22) PCT Filed: May 25, 2017
(86) PCT No.: PCT/JP2017/019560

§ 371 Date: Nov. 26, 2018

(30) Foreign Application Priority Data
May 26, 2016 (JP) 2016105097

(51) Int. Cl. B60C 13/00

(52) U.S. Cl. CPC B60C 13/001

(57) ABSTRACT

A pneumatic tire includes: an indicator portion on tire side portions located at opposite sides in a lateral direction; a first decorative portion on the side portion and arranged at a location different from a location in a tire circumferential direction of the indicator portion, the first decorative portion including ridges aligned in rows; and a second decorative portion on the side portion, wherein a portion in a radial direction occupies the same location in the radial direction as the first decorative portion, the second decorative portion being interposed between the indicator portion and the first decorative portion in the circumferential direction and arranged to be separated from the indicator portion and the first decorative portion, the second decorative portion including ridges aligned in rows, the ridges being oriented at an angle different from an angle of the ridges of the first decorative portion with respect to the radial direction.

### TECHNICAL FIELD

The present technology relates to a pneumatic tire.

### BACKGROUND ART

In many conventional pneumatic tires, a decorative portion indicating a brand name, a size, and the like of each of the pneumatic tires is formed on a surface of a sidewall portion. For example, a serration formed of plural small grooves is formed on an outer surface of a sidewall portion of a pneumatic tire described in Japan Patent No. 5520334. Groove depths of the small grooves are changed and thereby the contrast of light is clearly indicated and the visibility of markings is improved. Also, a pneumatic tire described in Japan Unexamined Patent Publication No. 2006-347202 includes a second decorative band formed in a tire circumferential direction and a first decorative band having an arc curved in the opposite direction to the second decorative band. Thus, in a case where a decorative portion is provided, elements continuously extending in the tire circumferential direction are reduced and the growth of cracks is prevented.

Here, during traveling of a vehicle, a pneumatic tire rotates while a sidewall portion is repeatedly deflected by a varying load acting on the pneumatic tire. Accordingly, in a case where a decorative portion formed of a serration is provided on the sidewall portion, stress is concentrated on an end portion of the decorative portion and therefore cracking may occur from the end portion. Such cracking can be partly inhibited by the decorative band that is formed in the tire circumferential direction to indicate letters as in Japan Unexamined Patent Publication No. 2006-347202. In addition, an arc decorative band is formed to be curved in the opposite direction to the curving direction of the decorative band formed in the tire circumferential direction; therefore, cracking can be partly inhibited. However, in a case where the different decorative bands are shaped to be curved in the opposite directions to each other and, as a result, the growth of cracks is inhibited, there may be limitation in appearance features. Therefore, visibility may deteriorate. Consequently, it is very difficult to improve durability while securing visibility and inhibiting the growth of cracks.

### SUMMARY

The present technology provides a pneumatic tire that can improve durability while securing visibility of a decorative portion.

A pneumatic tire according to the present technology includes: an information indicator portion provided on each of tire side portions located at opposite sides in a tire lateral direction; a first decorative portion provided on the tire side portion and arranged at a location different from a location in a tire circumferential direction in which the information indicator portion is provided, the first decorative portion including a plurality of ridges aligned in rows; and a second decorative portion provided on the tire side portion and configured such that at least a portion in a tire radial direction occupies the same location in the tire radial direction as the first decorative portion, the second decorative portion being interposed between the information indicator portion and the first decorative portion in the tire circumferential direction and arranged to be separated from the information indicator portion and the first decorative portion, the second decorative portion including ridges aligned in a plurality of rows, the ridges being oriented at an angle different from an angle of the ridges of the first decorative portion with respect to the tire radial direction.

In the foregoing pneumatic tire, a distance L1 in the tire circumferential direction between positions on a tread surface is established such that opposite end portions of the first decorative portion in the tire circumferential direction correspond to the positions in the tire circumferential direction, and a distance L2 in the tire circumferential direction between positions on the tread surface is established such that opposite end portions of the second decorative portion in the tire circumferential direction correspond to the positions in the tire circumferential direction. The first decorative portion and the second decorative portion may be configured such that the distance L1 and the distance L2 have the following relationship: 0.05≤(L2/L1)≤0.30.

In the foregoing pneumatic tire, the first decorative portion may be configured such that all the ridges of the first decorative portion on the same position in the tire radial direction form the same angle with respect to the tire radial direction, and the second decorative portion may be configured such that all the ridges of the second decorative portion on the same position in the tire radial direction form the same angle with respect to the tire radial direction.

In the foregoing pneumatic tire, the inclination in the tire circumferential direction of the ridges of the first decorative portion and the inclination in the tire circumferential direction of the ridges of the second decorative portion may be in the opposite direction from each other with respect to the tire radial direction.

In the foregoing pneumatic tire, markings formed of a plurality of ridges may be provided on a surface of the information indicator portion.

The foregoing pneumatic tire may further include a third decorative portion provided on the tire side portion and may be configured such that at least a portion in the tire circumferential direction occupies the same location in the tire circumferential direction as the second decorative portion. The third decorative portion may be located outward of the second decorative portion in the tire radial direction and arranged to be separated from the second decorative portion. The third decorative portion may include ridges aligned in a plurality of rows. The ridges may be oriented at an angle different from the angle of the ridges of the first decorative portion with respect to the tire radial direction.

The foregoing pneumatic tire may further include a fourth decorative portion provided on the tire side portion and may be configured such that at least a portion in the tire radial direction occupies the same location in the tire radial direction as the third decorative portion. The fourth decorative portion may be located in the tire circumferential direction closer to the first decorative portion than the third decorative portion, located outward of the first decorative portion in the tire radial direction, and arranged to be separated from the first decorative portion and the third decorative portion. The fourth decorative portion may include ridges aligned in a plurality of rows. The ridges may be oriented at an angle different from the angle of the ridges of the first decorative portion with respect to the tire radial direction.

A pneumatic tire according to the present technology achieves an effect that can improve durability while securing visibility of a decorative portion.

### BRIEF DESCRIPTION OF DRAWINGS

FIG. 1 is a meridian cross-sectional view illustrating a main portion of a pneumatic tire according to an embodiment.

FIG. 2 is a diagram as viewed in the direction indicated by arrows A-A of FIG. 1.

FIG. 3 is a detailed view of portion B of FIG. 2.

FIG. 4 is an explanatory diagram of ridges of a first decorative portion.

FIG. 5 is an explanatory diagram of ridges of a second decorative portion.

FIG. 6 is a cross-sectional view of the ridges illustrated in FIG. 3, as viewed in a direction in which the ridges extend.

FIG. 7 is an explanatory diagram of distances L1, L2 illustrated in FIG. 2.

FIG. 8 is a detailed view of portion C of FIG. 2.

FIG. 9 is a table showing the results of performance tests of pneumatic tires.

### DETAILED DESCRIPTION

A pneumatic tire according to an embodiment of the present technology will be described in detail below with reference to the drawings. However, the technology is not limited to the embodiment. Constituents of the following embodiment include elements that can be substituted or easily conceived by one skilled in the art or that are substantially identical.

In the descriptions below, a tire lateral direction refers to a direction that is parallel with a rotation axis of a pneumatic tire. Inward in the tire lateral direction refers to a direction toward a tire equatorial plane in the tire lateral direction. Outward in the tire lateral direction refers to a direction opposite to the direction toward the tire equatorial plane in the tire lateral direction. Further, a tire radial direction refers to a direction orthogonal to the rotation axis of the tire. Inward in the tire radial direction refers to a direction toward the rotation axis of the tire in the tire radial direction. Outward in the tire radial direction refers to a direction separating from the rotation axis of the tire in the tire radial direction. A tire circumferential direction refers to a direction of rotation about the rotation axis of the tire.

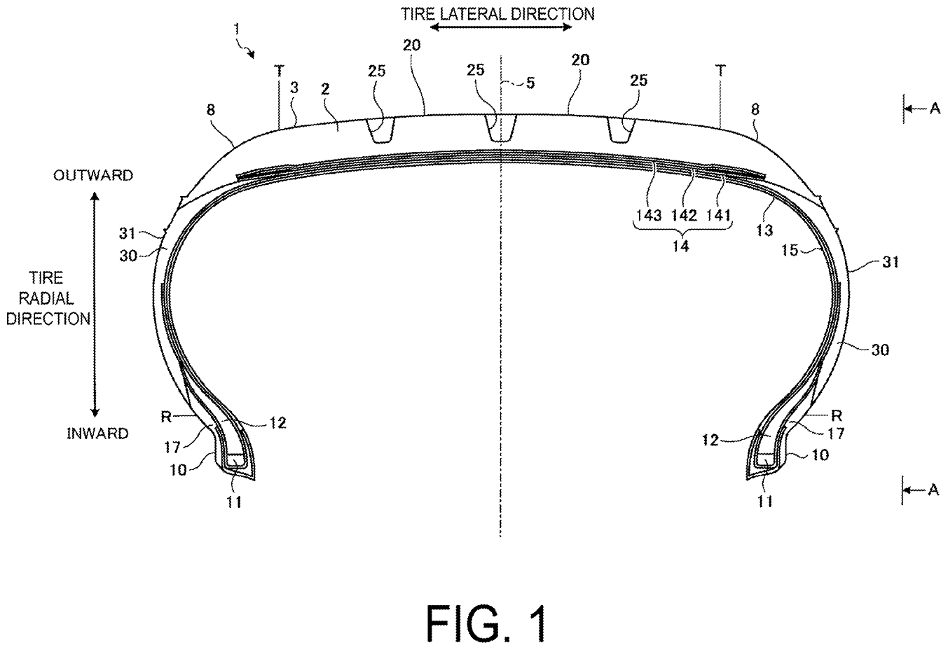

FIG. 1 is a meridian cross-sectional view illustrating a main portion of a pneumatic tire according to an embodiment. When viewed in the meridian cross-section, a pneumatic tire 1 illustrated in FIG. 1 is provided with a tread portion 2 in the outermost portion in the tire radial direction. A surface of the tread portion 2, i.e., a portion that comes into contact with a road surface when a vehicle (not illustrated) mounted with the pneumatic tire 1 travels, is formed as a tread surface 3. Plural circumferential main grooves 25 extending in the tire circumferential direction are formed in the tread surface 3 of the tread portion 2. In the tread surface 3, plural land portions 20 are defined by the circumferential main grooves 25. Grooves other than the circumferential main grooves 25 may be formed in the tread surface 3. Lug grooves (not illustrated) extending in the tire lateral direction or narrow grooves (not illustrated) different from the circumferential main grooves 25 may be formed on the tread surface 3.

Shoulder portions 8 are positioned at opposite ends of the tread portion 2 in the tire lateral direction. Sidewall portions 30 are disposed inward of the shoulder portions 8 in the tire radial direction. In other words, the two sidewall portions 30 are disposed at opposite sides of the pneumatic tire 1 in the tire lateral direction. Surfaces of the sidewall portions 30 are formed as tire side portions 31, and the tire side portions 31 are located at the opposite sides in the tire lateral direction. Each of the two tire side portions 31 faces a side opposite to the side at which the tire equatorial plane 5 is located in a tire lateral direction.

In this case, the tire side portion 31 refers to a surface that uniformly continues from a ground contact edge T of the tread portion 2 outward in the tire lateral direction, i.e., in a range from a rim check line R outward in the tire radial direction. Additionally, the ground contact edge T refers to either outermost edge in the tire lateral direction of a region, in which the tread surface 3 of the tread portion 2 of the pneumatic tire 1 contacts a road surface when the pneumatic tire 1 is mounted on a regular rim, inflated to a regular internal pressure, and loaded with 70% of a regular load. The ground contact edge T continuously extends in the tire circumferential direction. Moreover, the rim check line R is a line used to confirm whether the tire is normally mounted on the rim and, typically, is indicated as an annular convex line located closer to the outer side in the tire radial direction than a rim flange (not illustrated) and continuously extending in the tire circumferential direction along an adjoining part of the rim flange on a front side surface of a bead portion 10.

Note that the regular rim refers to an “applicable rim” defined by the JATMA (Japan Automobile Tyre Manufacturers Association Inc.), a “Design Rim” defined by the TRA (Tire and Rim Association, Inc.), or a “Measuring Rim” defined by the ETRTO (European Tyre and Rim Technical Organisation). Further, the “regular internal pressure” refers to a “maximum air pressure” defined by the JATMA, the maximum value in “TIRE LOAD LIMITS AT VARIOUS COLD INFLATION PRESSURES” defined by the TRA, or “INFLATION PRESSURES” defined by the ETRTO. Furthermore, the “regular load” refers to a “maximum load capacity” defined by the JATMA, the maximum value in “TIRE LOAD LIMITS AT VARIOUS COLD INFLATION PRESSURES” defined by the TRA, or “LOAD CAPACITY” defined by the ETRTO.

The bead portions 10 are located inward of the sidewall portions 30 in the tire radial direction, both of which are located at the opposite sides in the tire lateral direction. The two bead portions 10 are disposed at the opposite sides with respect to the tire equatorial plane 5 in the same way as the sidewall portions 30. Each of the bead portions 10 is provided with a bead core 11, and a bead filler 12 is provided outward of the bead core 11 in the tire radial direction.

In addition, plural belt layers 14 are provided inward of the tread portion 2 in the tire radial direction. The belt layers 14 include plural cross belts 141, 142 and a belt cover 143 and form a multilayer structure. Of the cross belts and the belt cover, plural belt cords made of steel or an organic fiber material are covered by coating rubber to be rolled and thereby the cross belts 141, 142 having a belt angle with an absolute value ranging from 20° to 55° are configured. Further, the plural cross belts 141, 142 include the belt cords different from each other. The belt cords are each defined as an inclination angle in the fiber direction of the belt cords with respect to the tire circumferential direction. In addition, the cross belts are layered as a so-called cross-ply structure so that the fiber directions of the belt cords intersect each other. Furthermore, plural cords made of steel covered by coating rubber or made of an organic fiber material are rolled and thereby the belt cover 143 having a belt angle with an absolute value ranging from 0° to 10° is configured. The belt cover 143 is disposed in a layer outward of the cross belts 141, 142 in the tire radial direction.

A carcass 13 facing the tire equatorial plane 5 and internally including a radial-ply cord is continuously provided inward of the belt layers 14 in the tire radial direction and on the side of the sidewall portions 30. The carcass 13 has a single layer structure made of one carcass ply or a multilayer structure made of plural carcass plies, and extends in a toroidal form between the bead cores 11 at the opposite sides in the tire lateral direction, therefore configuring the framework of the tire. Specifically, the carcass 13 is disposed from one of the bead portions 10 located at the opposite sides in the tire lateral direction to the other of the bead portions 10, and turns back outward in the tire lateral direction along the bead portions 10 and the bead cores 11, wrapping around the bead cores 11 and the bead fillers 12. The carcass ply (plies) of the carcass 13 is formed as below. Plural carcass cords made of steel or an organic fiber material such as aramid, nylon, polyester, or rayon is covered by coating rubber to be rolled, and thereby the carcass ply (plies) is configured, having a carcass angle, i.e., an inclination angle in the fiber direction of the carcass cords with respect to the tire circumferential direction, with an absolute value ranging from 80° to 95°.

A rim cushion rubber 17 is disposed inward in the tire radial direction and outward in the tire lateral direction with respect to the bead core 11 and a turned back portion of the carcass 13 at the bead portion 10. The rim cushion rubber 17 configures a contact surface of the bead portion 10 to contact with the rim flange. Additionally, an inner liner 15 is formed along the carcass 13 inward of the carcass 13 or on the inner side of the carcass 13 in the pneumatic tire 1.

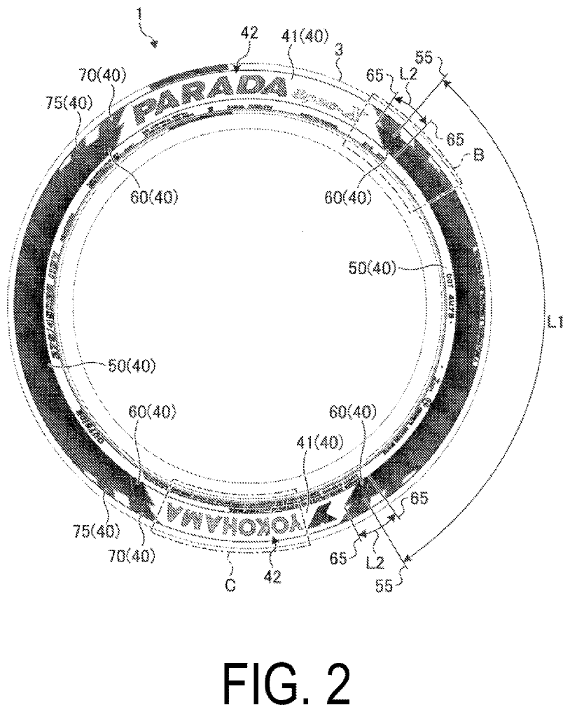

FIG. 2 is a diagram as viewed in the direction indicated by arrows A-A of FIG. 1. A decorative portion 40 is provided on the tire side portion 31 for the purpose of improvement of the appearance of the pneumatic tire 1 or indication of various information. The decorative portion 40 includes information indicator portions 41, first decorative portions 50, second decorative portions 60, third decorative portions 70, and fourth decorative portions 75. Of these portions, each of the information indicator portions 41 indicates a brand name, a logo, a product name, or the like for identification of the pneumatic tire 1 or indicates various information to be offered to a user. Further, the first decorative portions 50 are arranged at positions different from the positions at which the information indicator portions 41 are provided in the tire circumferential direction.

In the embodiment, the two information indicator portions 41 are provided on the single tire side portion 31 in the tire circumferential direction, and each of the two first decorative portions 50 is provided so as to be located between the two information indicator portions 41 in the tire circumferential direction. Furthermore, each of the second decorative portions 60 is arranged so as to be located between the information indicator portion 41 and the first decorative portion 50 in the tire circumferential direction while having a length in the tire circumferential direction, which is smaller than a length of the first decorative portion 50 in the tire circumferential direction. In other words, the second decorative portions 60 are arranged between the two information indicator portions 41 interposed between the first decorative portions 50 in the tire circumferential direction, and each of the second decorative portions 60 is interposed between one of the information indicator portions 41 of the first decorative portions 50 and one of opposite end portions of a corresponding one of the first decorative portions 50 in the tire circumferential direction. Therefore, in the embodiment, the two second decorative portions 60 are respectively arranged at the opposite sides of the single first decorative portion 50 in the tire circumferential direction, that is, the four second decorative portions 60 are arranged on the single tire side portion 31.

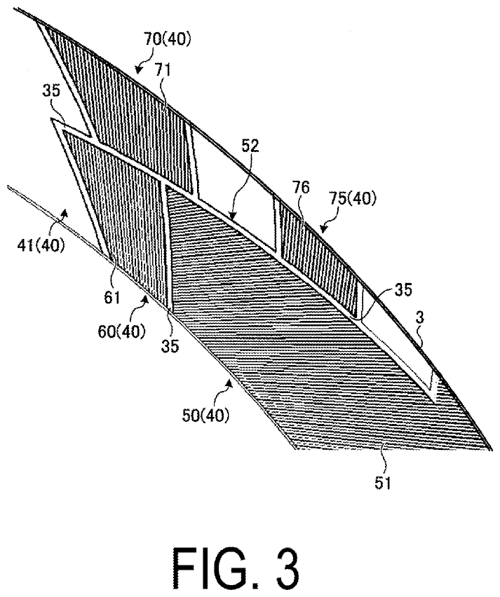

FIG. 3 is a detailed view of portion B of FIG. 2. The second decorative portions 60 arranged at opposite ends of the first decorative portion 50 in the tire circumferential direction are respectively configured such that at least a portion in the tire radial direction occupies the same location in the tire radial direction as the first decorative portion 50. Specifically, small-diameter portions 52 each having an outer diameter smaller than those of other portions of the first decorative portion 50 are provided near the opposite ends of the first decorative portion 50 in the tire circumferential direction. An outer circumferential portion of the small-diameter portion 52 in the tire radial direction is located in the tire radial direction inward of an outer circumferential portion of a portion of the first decorative portion 50, which is located between the small-diameter portions 52 in the tire circumferential direction. Thus, the outer diameter of the small-diameter portion 52 is smaller than the outer diameter of the portion of the first decorative portion 50, which is located between the small-diameter portions 52.

More specifically, the outer circumferential portion of the portion of the first decorative portion 50, which is located between the small-diameter portions 52 in the tire circumferential direction, is formed in a circular arc shape about the rotation axis of the pneumatic tire 1. The small-diameter portion 52 is formed to be curved such that the diameter of the outer circumferential portion in the tire radial direction decreases toward the end portion in the tire circumferential direction. Meanwhile, a diameter of an inner circumferential portion of the small-diameter portion 52 in the tire radial direction is the same size as a diameter of an inner circumferential portion of the portion of the first decorative portion 50, which is located between the small-diameter portions 52 in the tire circumferential direction. Therefore, the inner circumferential portion of the first decorative portion 50 is formed in the tire circumferential direction to have a circular arc shape about the rotation axis of the pneumatic tire 1.

The second decorative portion 60 is arranged side by side with the end portion of the small-diameter portion 52 of the first decorative portion 50, which is located adjacent to the information indicator portion 41 in the tire circumferential direction. Thus, the second decorative portion 60 is shaped such that an outer circumferential portion and an inner circumferential portion in the tire radial direction are respectively extended from the outer circumferential portion and the inner circumferential portion of the small-diameter portion 52 of the first decorative portion 50. Therefore, the outer circumferential portion of the second decorative portion 60 in the tire radial direction is configured such that a portion located adjacent to the first decorative portion 50 in the tire circumferential direction has a diameter in the tire radial direction, which is substantially the same size as a diameter in the tire radial direction of the end portion of the small-diameter portion 52, which is located adjacent to the second decorative portion 60. In addition, the second decorative portion 60 is configured such that the diameter in the tire radial direction decreases toward the information indicator portion 41. In other words, the small-diameter portion 52 of the first decorative portion 50 and the second decorative portion 60 are formed such that the width in the tire radial direction decreases toward the information indicator portion 41 in the tire circumferential direction.

As described above, since the second decorative portion 60 is formed in a shape extended from the small-diameter portion 52 of the first decorative portion 50, at least a portion of the second decorative portion 60, which is located in the tire radial direction is formed to occupy the same location in the tire radial direction as the first decorative portion 50. Further, the second decorative portion 60 is arranged to be separated from the information indicator portion 41 and the first decorative portion 50. In other words, clearances 35 are formed between the information indicator portion 41 and the second decorative portion 60 and between the first decorative portion 50 and the second decorative portion 60. The information indicator portion 41 and the second decorative portion 60 are disposed side by side via the clearance 35 and thus are separated from each other, and the first decorative portion 50 and the second decorative portion 60 are disposed side by side via the clearance 35 and thus are separated from each other. No decorative portion 40 is formed in the clearance 35 on the tire side portion 31 and thus a planer portion of the tire side portion 31 is exposed. The clearances 35 are respectively formed between the information indicator portion 41 and the second decorative portion 60 and between the small-diameter portion 52 of the first decorative portion 50 and the second decorative portion 60; therefore, the information indicator portion 41, the second decorative portion 60, and the small-diameter portion 52 of the first decorative portion 50 are arranged in a row and separated in the tire circumferential direction. In addition, the width of the clearance 35 is preferably 150% to 250% of a distance between ridges 51 of the first decorative portion 50.

Furthermore, the ridges 51 each as a protruded portion protruding in a mount shape are arranged in multiple rows and thereby the first decorative portion 50 is formed. The ridges 51 are aligned without intersecting one another, and the multiple ridges 51 are aligned and thereby the first decorative portion 50 is formed. Likewise, plural ridges 61 are aligned without intersecting one another and thereby the second decorative portion 60 is formed. The ridges 61 of the second decorative portion 60 are formed at an angle different from an angle of the ridges 51 of the first decorative portion 50 with respect to the tire radial direction.

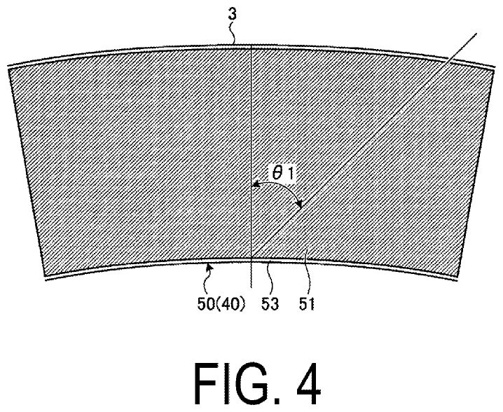

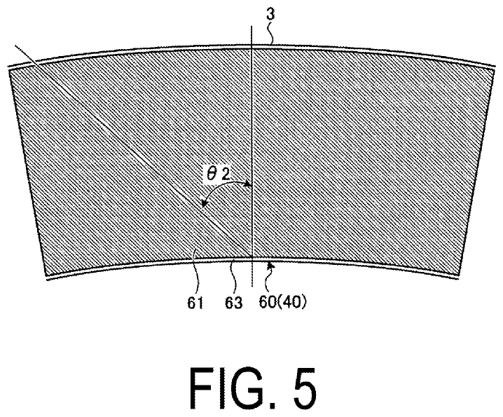

FIG. 4 is an explanatory diagram of the ridges of the first decorative portion. FIG. 5 is an explanatory diagram of the ridges of the second decorative portion. The inclination in the tire circumferential direction of the ridges 51 of the first decorative portion 50 and the inclination in the tire circumferential direction of the ridges 61 of the second decorative portion 60 are in the opposite direction from each other with respect to the tire radial direction. For example, the ridges 51 of the first decorative portion 50 are inclined clockwise from the inner side to the outer side in the tire radial direction. In this case, the ridges 61 of the second decorative portion 60 are inclined counterclockwise from the inner side to the outer side in the tire radial direction. As described above, the ridges 51 of the first decorative portion 50 and the ridges 61 of the second decorative portion 60 are formed to be inclined in the opposite direction from each other with respect to the tire radial direction, and the ridges 51 and the ridges 61 are respectively formed linearly when viewed from the front of the tire side portion 31.

Further, the first decorative portion 50 is configured such that all angles θ1, with respect to the tire radial direction, of the plural ridges 51 of the first decorative portion 50 on the same position in the tire radial direction are identical to each other. For example, all angles θ1 of the plural ridges 51 of the first decorative portion 50 with respect to the tire radial direction are identical to each other when measured on an inner end rim 53 formed into a circular arc shape about the rotation axis of the pneumatic tire 1 and corresponding to the inner circumferential portion of the first decorative portion 50 in the tire circumferential direction. Likewise, all angles θ2 of the plural ridges 61 of the second decorative portion 60 with respect to the tire radial direction are identical to each other when measured on an inner end rim 63 formed into a circular arc shape about the rotation axis of the pneumatic tire 1 and corresponding to the inner circumferential portion of the second decorative portion 60 in the tire circumferential direction.

In addition, when measured on the inner end rim 53, the angle θ1 of the ridges 51 of the first decorative portion 50 with respect to the tire radial direction is preferably 30° to 90°. Likewise, when measured on the inner end rim 63, the angle θ2 of the ridges 61 of the second decorative portion 60 with respect to the tire radial direction is preferably 30° to 90°, and the inclination in the tire circumferential direction of the ridges 61 is preferably in the opposite direction from the inclination in the tire circumferential direction of the ridges 51 of the first decorative portion 50 with respect to the tire radial direction.

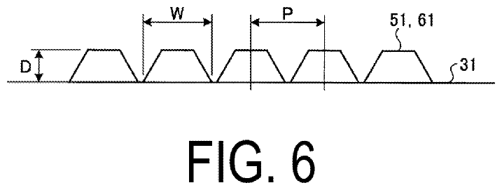

FIG. 6 is a cross-sectional view of the ridges illustrated in FIG. 3, as viewed in a direction in which the ridges extend. Each of the ridges 51, 61 of the first decorative portion 50 and the second decorative portion 60 is formed such that a depth D ranges from 0.1 mm to 0.8 mm, a width W ranges from 0.1 mm to 0.8 mm, and a distance P between the ridges 51, 61 located side by side ranges from 0.3 mm to 1.0 mm.

Additionally, the first decorative portion 50 and the second decorative portion 60 are configured on the tread surface 3 such that a distance L1 in the tire circumferential direction (see FIG. 2) between the opposite end portions of the first decorative portion 50 and a distance L2 (see FIG. 2) in the tire circumferential direction between the opposite end portions of the second decorative portion 60 have the following relationship: 0.05≤(L2/L1)≤0.30.

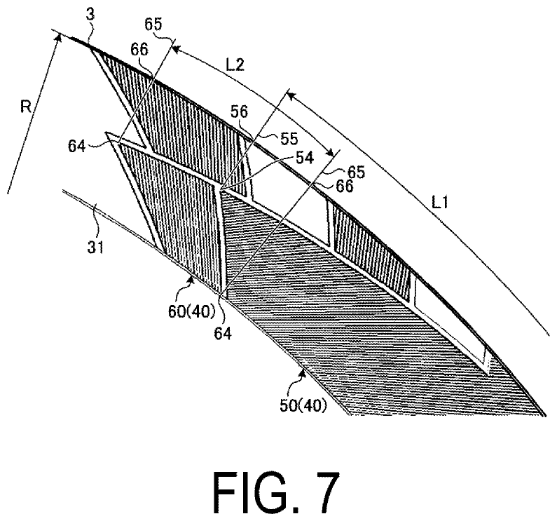

FIG. 7 is an explanatory diagram of the distances L1, L2 illustrated in FIG. 2. The distance L1 in the tire circumferential direction between the opposite end portions 54 of the first decorative portion 50 located on the tread surface 3 corresponds to a distance in the tire circumferential direction between positions on the tread surface 3 such that the opposite end portions 54 of the first decorative portion 50 are identical to the positions in the tire circumferential direction. In other words, the distance L1 corresponds to a distance in the tire circumferential direction between intersection portions 56 where perpendicular lines 55 each drawn in the tire radial direction from the position of the end portion 54 of the first decorative portion 50 toward the tread surface 3 intersect with the tread surface 3. In this case, a portion intersecting with the perpendicular line 55 on the tread surface 3 is an end portion in the tire lateral direction on the tread surface 3.

Likewise, the distance L2 in the tire circumferential direction between the opposite end portions of the second decorative portion 60 located on the tread surface 3 corresponds to a distance in the tire circumferential direction between positions on the tread surface 3 such that the opposite end portions 64 of the second decorative portion 60 are identical to the positions in the tire circumferential direction. In other words, the distance L2 corresponds to a distance in the tire circumferential direction between intersection portions 66 where perpendicular lines 65 each drawn in the tire radial direction from the position of the end portion 64 of the second decorative portion 60 toward the tread surface 3 intersect with the tread surface 3. In this case, in the same as the distance L1, a portion intersecting with the perpendicular line 65 on the tread surface 3 is the end portion in the tire lateral direction on the tread surface 3. The first decorative portion 50 and the second decorative portion 60 are formed such that the relationship between the distance L1 and the distance L2 is within a range of 0.05≤(L2/L1)≤0.30.

In addition, the distance L1 in the tire circumferential direction between the opposite end portions 54 of the first decorative portion 50 located on the tread surface 3 is preferably equal to or lower than R×(½)πrad where R is a radius in the tire radial direction of a portion for measuring the distance L1 on the tread surface 3. That is, when the distance L1 or the distance L1 is measured at the end portion in the tire lateral direction on the tread surface 3, the first decorative portion 50 is formed such that the distance L1 is equal to or lower than R×(½)πrad where R is a radius of the end portion in the tire lateral direction on the tread surface 3. In other words, the first decorative portion 50 is preferably formed in a range of 90° or lower in the tire circumferential direction on the tire side portion 31.

Additionally, the third decorative portion 70 and the fourth decorative portion 75 are provided on the tire side portion 31 to be located near the small-diameter portion 52 of the first decorative portion 50 and the second decorative portion 60. Of the decorative portions, the third decorative portion 70 is configured such that at least a portion located in the tire circumferential direction occupies the same location in the tire circumferential direction as the second decorative portion 60, and the third decorative portion 70 is arranged outward of the second decorative portion 60 in the tire radial direction to be separated from the second decorative portion 60.

Specifically, one end portion of the third decorative portion 70, which is located adjacent to the first decorative portion 50 in the tire circumferential direction is further projected toward the first decorative portion 50 than one end portion of the second decorative portion 60, which is located adjacent to the first decorative portion 50 in the tire circumferential direction. The other end portion of the third decorative portion 70, which is located adjacent to the information indicator portion 41 in the tire circumferential direction is further projected toward the information indicator portion 41 than the other end of the second decorative portion 60, which is located adjacent to the information indicator portion 41 in the tire circumferential direction. Further, an inner circumferential portion of the third decorative portion 70 in the tire radial direction is formed in parallel with the outer circumferential portion of the small-diameter portion 52 of the first decorative portion 50 and the outer circumferential portion of the second decorative portion 60 having the shape extended from the outer circumferential portion of the small-diameter portion 52 of the first decorative portion 50. The third decorative portion 70 is separated via the clearance 35 from the small-diameter portion 52 of the first decorative portion 50 and the second decorative portion 60.

Furthermore, an outer circumferential portion of the third decorative portion 70 in the tire radial direction is formed in a circular arc shape about the rotation axis of the pneumatic tire 1. A diameter of the outer circumferential portion of the third decorative portion 70 has substantially the same size as the diameter of the outer circumferential portion of the first decorative portion 50, which is located between the small-diameter portions 52 in the tire circumferential direction. The third decorative portion 70 formed as just described includes ridges 71 aligned in plural rows. The ridges 71 are disposed at an angle different from the angle of the ridges 51 of the first decorative portion 50 with respect to the tire radial direction. Specifically, the orientation and angle of the ridges 71 of the third decorative portion 70 are the same as the orientation and angle of the ridges 61 of the second decorative portion 60 with respect to the tire radial direction.

Additionally, the fourth decorative portion 75 is arranged outward of the small-diameter portion 52 of the first decorative portion 50 in the tire radial direction to be separated from the first decorative portion 50 and the third decorative portion 70. Further, the fourth decorative portion 75 is located closer to the first decorative portion 50 than the third decorative portion 70 in the tire circumferential direction. At least a portion of the fourth decorative portion 75, which is located in the tire radial direction occupies the same location in the tire radial direction as the third decorative portion 70.

Specifically, opposite end portions of the fourth decorative portion 75 in the tire circumferential direction are formed in the tire circumferential direction within a range between opposite end portions of one of the small-diameter portions 52 of the first decorative portion 50. Furthermore, an inner circumferential portion of the fourth decorative portion 75 in the tire radial direction is formed in parallel with the outer circumferential portion of the small-diameter portion 52 of the first decorative portion 50. The fourth decorative portion 75 is separated via the clearance 35 from the small-diameter portion 52 of the first decorative portion 50. An outer circumferential portion of the fourth decorative portion 75 in the tire radial direction is formed in a circular arc shape about the rotation axis of the pneumatic tire 1. A diameter of the outer circumferential portion of the fourth decorative portion 75 is substantially the same size as the diameter of the outer circumferential portion of the first decorative portion 50, which located between the small-diameter portions 52 in the tire circumferential direction.

The fourth decorative portion 75 formed as described above includes ridges 76 aligned in plural rows. The ridges 76 are disposed at an angle different from the angle of the ridges 51 of the first decorative portion 50 with respect to the tire radial direction. Specifically, the orientation and angle of the ridges 76 of the fourth decorative portion 75 are the same as the orientation and angle of the ridges 61 of the second decorative portion 60 and the orientation and angle of the ridges 71 of the third decorative portion 70.

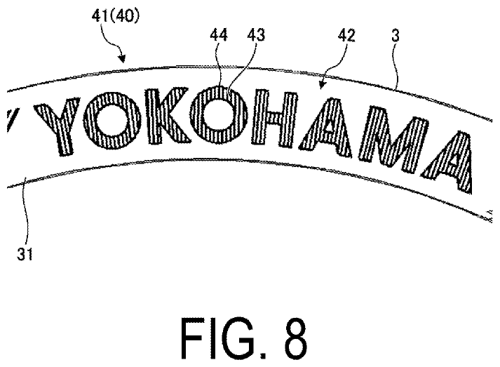

FIG. 8 is a detailed view of portion C of FIG. 2. Markings 42 indicating a brand or the like are provided on the information indicator portion 41. Protruded and recessed portions in shapes copying letters, graphics, or the like are formed and thereby the markings 42 can indicate desired information. Plural ridges 43 are formed on a surface of the markings 42 of the information indicator portion 41. In the embodiment, a protruded portion 44 is formed in a rimmed shape of a desired letter and thereby the letter is indicated, and a plurality of such rimmed shapes of letters are formed. Thus, the markings 42 indicate a brand or the like. The plural ridges 43 are formed inside the protruded portion 44 of the rimmed shape forming the markings 42. All angles, with respect to the tire radial direction, of the ridges 43 of the markings 42 on the same position in the tire radial direction are identical to each other. For example, all of the plural ridges 43 are formed to extend in the tire radial direction.

When such a pneumatic tire 1 is mounted on a vehicle and the vehicle is driven, the pneumatic tire 1 rotates while the tread surface 3 of the tread surface 3 located at the bottom comes into contact with a road surface. In a case where a vehicle mounted with the pneumatic tire 1 is driven on a dry road surface, the vehicle runs by transferring driving force or braking force by friction force mainly between the tread surface 3 and the road surface or runs by generating turning force.

Also, during traveling of the vehicle, the pneumatic tire 1 is rotating while being consistently deflected. A load acting on the pneumatic tire 1 due to acceleration or cornering or due to unevenness of the road surface changes from moment to moment, and deflection of the tire changes. Specifically, deflection is likely to occur in the sidewall portion 30 in which a load is transferred between the bead portion 10 to which a rim wheel (not illustrated) is fitted and the tread portion 2 that includes the tread surface 3 contacting the road surface. This deflection changes from moment to moment during traveling of the vehicle. In other words, during traveling of the vehicle, the magnitude or acting direction of a load acting on the sidewall portion 30 changes from moment to moment in accordance with changes in the magnitude of a load acting on the pneumatic tire 1 or in accordance with the rotation of the pneumatic tire 1. Therefore, during running of the vehicle, the deflection of the sidewall portion 30 changes from moment to moment in accordance with changes in the magnitude or acting direction of the load acting on the tire.

Consequently, stress concentration may occur in portions of the pneumatic tire 1. When the stress is large or deflection repeatedly occurs in the case of occurrence of stress concentration, cracking may occur. Stress concentration is likely to occur in a portion where the shape is changing. Therefore, for example, in the decorative portion 40 formed on the tire side portion 31, stress concentration is likely to occur in an end portion of the first decorative portion 50 in the tire circumferential direction including the largest number of ridges 51 all having the same inclination angles with respect to the tire radial direction.

In other words, since the first decorative portion 50 is formed of the ridges 51 arranged in multiple rows, stress is uniformly distributed along the ridges 51 in an area of the tire side portion 31 where the first decorative portion 50 is formed. The ridges 51 along which stress concentration is uniformly distributed as described above discontinue at the end portion of the first decorative portion 50. Therefore, stress concentration is likely to occur, and cracking is likely to occur in the vicinity of an end of the ridges 51, which is located at the end portion of the first decorative portion 50, in the direction in which the ridges 51 are formed.

Here, the second decorative portions 60 are respectively arranged via the clearances 35 at the opposite ends of the first decorative portion 50 in the tire circumferential direction. Each of the second decorative portions 60 is configured such that the ridges 61 are oriented with respect to the tire radial direction at the angle different from the angle of the ridges 51 of the first decorative portion 50 with respect to the tire radial direction. Therefore, cracking that has occurred in the vicinity of the end portion of the first decorative portion 50 in the tire circumferential direction is stopped at the ridges 61 of the second decorative portions 60 and does not easily grow further beyond the ridges 61. Further, since the length of the second decorative portion 60 in the tire circumferential direction is shorter than the length of the first decorative portion 50 in the tire circumferential direction, the length of each of the ridges 61 is relatively short compared with the length of each of the ridges 51 of the first decorative portion 50. Therefore, an area where stress concentration may occur along the ridges 61 is reduced in the second decorative portion 60, compared with the first decorative portion 50. In addition, a large stress concentration does not easily occur in the second decorative portion 60. Consequently, cracking hardly occur due to stress concentration in the vicinity of the end portion of the second decorative portion 60 in the tire circumferential direction. As a result, the decorative portion 40 can inhibit the occurrence of cracking due to the establishment of the ridges 51, 61 and can improve durability.

Additionally, the markings 42 are provided on the information indicator portion 41, and the second decorative portions 60 are arranged at opposite sides of each of the information indicator portions 41 in the tire circumferential direction while being interposed between the first decorative portions 50. Each of the second decorative portions 60 is configured such that the ridges 61 are oriented with respect to the tire radial direction at the angle different from the angle of the ridges 51 of the first decorative portion 50, and the second decorative portion 60 is easily-noticeable on the tire side portion 31. Therefore, the information indicator portion 41, the opposite sides of which are sandwiched between the second decorative portions 60 in the tire circumferential direction, is easily-noticeable on the tire side portion 31. Consequently, visibility of the information indicator portion 41 including the markings 42 is enhanced. As a result, durability can be enhanced while visibility of the decorative portion 40 is ensured.

Further, the first decorative portion 50 and the second decorative portion 60 are configured such that the distance L1 in the tire circumferential direction between the opposite end portions of the first decorative portion 50 on the tread surface 3 and the distance L2 in the tire circumferential direction between the opposite end portions of the second decorative portion 60 on the tread surface 3 have the following relationship: 0.05≤(L2/L1)≤0.30. Therefore, the occurrence of cracking can be further surely inhibited. In other words, when (L2/L1)<0.05, the length of the second decorative portion 60 in the tire circumferential direction is too short. Therefore, when cracking occurs in the end portion of the first decorative portion 50, the growth of cracks may not be easily stopped by the second decorative portion 60. Furthermore, when (L2/L1)>0.30, the length of the second decorative portion 60 in the tire circumferential direction is too long. Therefore, when the sidewall portion 30 is repeatedly deflected, a large stress concentration occurs in the second decorative portion 60 and thus cracking may occur in the end portion of the second decorative portion 60 in the tire circumferential direction.

For such cracking, in the embodiment, the first decorative portion 50 and the second decorative portion 60 are formed in a range of 0.05≤(L2/L1)≤0.30. Therefore, even when the sidewall portion 30 is repeatedly deflected, cracking can be inhibited from occurring in the vicinity of the end portion of the first decorative portion 50 or the second decorative portion 60. As a result, durability of the decorative portion 40 can be further surely enhanced.

In addition, all the angles, with respect to the tire radial direction, of the plural ridges 51 of the first decorative portion 50 on the same position in the tire radial direction are identical to each other. Therefore, when viewed as a whole of the first decorative portion 50, uniformity of the first decorative portion 50 can be improved. Likewise, all the angles, with respect to the tire radial direction, of the plural ridges 61 of the second decorative portion 60 on the same position in the tire radial direction are identical to each other. Therefore, when viewed as a whole of the second decorative portion 60, uniformity of the second decorative portion 60 can be improved. Thus, physical appearance of the first decorative portion 50 or the second decorative portion 60 can be improved. In addition, the information indicator portion 41 arranged between the second decorative portions 60 becomes more easily-noticeable. As a result, the visibility of the decorative portion 40 can be further surely enhanced.

Further, the inclination in the tire circumferential direction of the ridges 51 of the first decorative portion 50 and the inclination in the tire circumferential direction of the ridges 61 of the second decorative portion 60 are in the opposite direction from each other with respect to the tire radial direction. Therefore, cracking can be further surely inhibited from occurring in the vicinity of the end portion of the first decorative portion 50 in the tire circumferential direction by the second decorative portion 60. Furthermore, the inclination of the ridges 51 and the inclination of the ridges 61 are set in the opposite direction from each other with respect to the tire radial direction. Therefore, the second decorative portion 60 becomes further surely easily-noticeable. As a result, more surely, the durability can be improved while the visibility of the decorative portion 40 is secured.

Moreover, the plural ridges 43 are formed on the surface of the markings 42 of the information indicator portion 41. Therefore, the markings 42 become easily-noticeable by the ridges 43. As a result, the visibility of the decorative portion 40 can be further surely enhanced.

Further, the third decorative portion 70 is located outward of the second decorative portion 60 in the tire radial direction in a state where the clearance 35 is interposed between the second decorative portion 60 and the third decorative portion 70. The third decorative portion 70 includes the ridges 71 aligned in plural rows at the angle different from the angle of the ridges 51 of the first decorative portion 50 with respect to the tire radial direction. Accordingly, an adjoining part of either end of the first decorative portion 50 in the tire circumferential direction becomes easily-noticeable. Therefore, physical appearance of the adjoining part of either end of the first decorative portion 50 can be further surely enhanced. Furthermore, even when cracking outward in the tire radial direction occurs in the vicinity of the end portion of the first decorative portion 50 in the tire circumferential direction, the growth of cracks can be inhibited by the third decorative portion 70. Moreover, the adjoining part of either end of the first decorative portion 50 is enhanced and thereby the information indicator portion 41 becomes further surely easily-noticeable. As a result, more surely, the durability can be improved while the visibility of the decorative portion 40 is secured.

Further, the fourth decorative portion 75 is located outward of the small-diameter portion 52 of the first decorative portion 50 in the tire radial direction in a state where the clearance 35 is interposed between the small-diameter portion 52 and the fourth decorative portion 75. The fourth decorative portion 75 includes the ridges 76 aligned in plural rows at the angle different from the angle of the ridges 51 of the first decorative portion 50 with respect to the tire radial direction. Accordingly, an adjoining part of the small-diameter portion 52 becomes easily-noticeable. Therefore, physical appearance of the adjoining part of either end of the first decorative portion 50 can be further surely enhanced. Furthermore, the fourth decorative portion 75 is arranged outward of the small-diameter portion 52 of the first decorative portion 50 in the tire radial direction. Therefore, designability of the adjoining part of the end portion of the first decorative portion 50 in the tire circumferential direction can be improved and the physical appearance can be enhanced. Moreover, the fourth decorative portion 75 is arranged outward of the small-diameter portion 52 of the first decorative portion 50 in the tire radial direction. Therefore, even when cracking occurs from the small-diameter portion 52 outward in the tire radial direction, such cracking can be inhibited by the fourth decorative portion 75. As a result, more surely, the durability can be improved while the visibility of the decorative portion 40 is secured.

### Embodiments

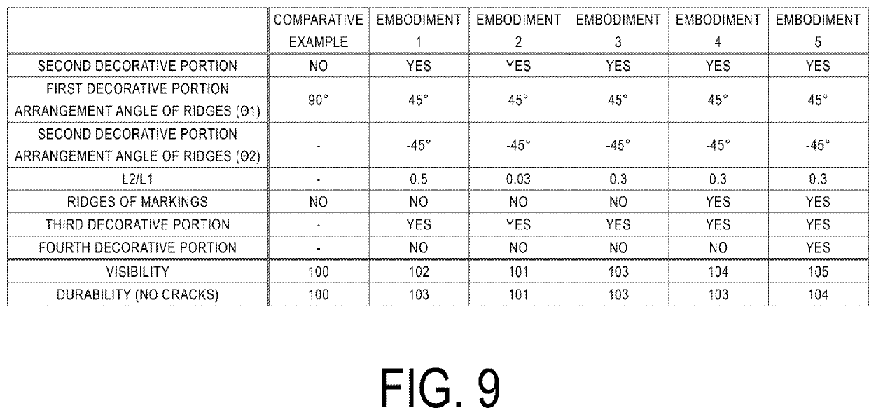

FIG. 9 is a table showing the results of performance tests of pneumatic tires. For the pneumatic tire 1 described above, performance evaluation tests conducted on a pneumatic tire 1 of a comparative example and a pneumatic tire 1 according to the present technology will be described below. The performance evaluation tests are conducted on the visibility of the decorative portion 40 and the durability of the sidewall portion 30.

For the visibility in the performance evaluation tests, an evaluator visually evaluates how much the markings 42 of the information indicator portion 41 provided on the sidewall portion 30 of each of the pneumatic tires 1 are noticeable. Evaluation results of the visibility are calculated by using an index value of 100 for the visibility of the markings 42 of the information indicator portion 41 of the pneumatic tire 1 of the comparative example described below. Larger index values indicate superior in the visibility of the markings 42.

Also, the evaluation tests on the durability are conducted by mounting the pneumatic tires 1 with a nominal tire size: 275/45R20 110V specified by the JATMA to a rim wheel of JATMA standard rims with a size 2.0×9.0 and by using the pneumatic tire 1, air pressure of which is adjusted to 100 kPa. For the durability in the evaluation tests, a load of 4.5 kN is applied by an indoor drum testing machine to each of the pneumatic tires 1 to be tested, and then the outer surface of the sidewall portion 30 is exposed to ozone with concentration of 100 pphm at a distance of 10 mm from the outer surface. Thereafter, the tires are driven at the speed of 80 km/h continuously for 500 hours. After the tires are driven, the number of cracks generated on each of the tires is measured and evaluated. In the evaluation tests, an evaluator visually evaluates the occurrence and growth of cracks in the vicinity of the end portion of the first decorative portions 50 in the tire circumferential direction on the sidewall portion 30, specifically, in an area within 50 mm from the end portion of the first decorative portions 50. In this case, each of cracks, with the length of 1.5 mm or larger and the length of 5 mm or larger is counted as one crack. The evaluation results on the durability are calculated by using an index value of 100 for the number of cracks generated on the pneumatic tire 1 of the comparative example described below. Larger values indicate superior durability, and specifically indicate that the number of generated cracks is small and the growth of cracks is inhibited.

The evaluation tests are conducted on six pneumatic tires 1 of the pneumatic tires 1 according to first to fifth embodiments of the present technology and the pneumatic tire 1 of the comparative example to be compared with the pneumatic tires 1 according to the present technology. For all of the pneumatic tires 1, the tire side portion 31 is provided with the information indicator portion 41 including the markings 42 and with the first decorative portion 50. Of the pneumatic tires 1, the pneumatic tire 1 of the comparative example is not provided with the second decorative portion 60. Compared with the comparative example, in the first to fifth embodiments as an example of the pneumatic tire 1 according to the present technology, all of the pneumatic tires are provided with the second decorative portions 60. Further, the pneumatic tires 1 according to the first to fifth embodiments are different from one another in: a ratio between the distance L1 between the opposite end portions 54 of the first decorative portion 50 on the tread surface 3 and the distance L2 between the opposite end portions 64 of the second decorative portion 60 on the tread surface 3; the presence or absence of the ridges 43 of the markings 42; and the presence or absence of the third decorative portion 70 or the fourth decorative portion 75. Additionally, in FIG. 9, for the arrangement angle θ1 of the ridges 51 of the first decorative portion 50 and the arrangement angle θ2 of the ridges 61 of the second decorative portion 60, the inclination in the tire circumferential direction of the ridges 51 of the first decorative portion 50 with respect to the tire radial direction is defined as + (plus), and the inclination in the tire circumferential direction of the ridges 61 of the second decorative portion 60 with respect to the tire radial direction is defined as − (minus).

As the results of the evaluation tests conducted with the use of the pneumatic tires 1, it was found as illustrated in FIG. 9 that the visibility and the durability are both improved in the pneumatic tires 1 according to the first to fifth embodiments, compared with the comparative example. In other words, with the pneumatic tires 1 according to the first to fifth embodiments, the durability can be enhanced while the visibility of the decorative portion 40 is secured.

1. A pneumatic tire, comprising:
an information indicator portion provided on each of tire side portions located at opposite sides in a tire lateral direction;
a first decorative portion provided on the tire side portion and arranged at a location different from a location in a tire circumferential direction in which the information indicator portion is provided, the first decorative portion including a plurality of ridges aligned in rows; and
a second decorative portion provided on the tire side portion and configured such that at least a portion in a tire radial direction occupies a same location in the tire radial direction as the first decorative portion, the second decorative portion being interposed between the information indicator portion and the first decorative portion in the tire circumferential direction and arranged to be separated from the information indicator portion and the first decorative portion, the second decorative portion including ridges aligned in a plurality of rows, the ridges being oriented at an angle different from an angle of the ridges of the first decorative portion with respect to the tire radial direction.

2. The pneumatic tire according to claim 1, wherein
a distance L1 in the tire circumferential direction between positions on a tread surface is established such that opposite end portions of the first decorative portion in the tire circumferential direction correspond to the positions in the tire circumferential direction,
a distance L2 in the tire circumferential direction between positions on the tread surface is established such that opposite end portions of the second decorative portion in the tire circumferential direction correspond to the positions in the tire circumferential direction, and
the first decorative portion and the second decorative portion are configured such that the distance L1 and the distance L2 have relationship below: 0.05≤(L2/L1)≤0.30.

3. The pneumatic tire according to claim 1, wherein
the first decorative portion is configured such that all the ridges of the first decorative portion on a same position in the tire radial direction form a same angle with respect to the tire radial direction, and
the second decorative portion is configured such that all the ridges of the second decorative portion on a same position in the tire radial direction form a same angle with respect to the tire radial direction.

4. The pneumatic tire according to claim 1, wherein inclination in the tire circumferential direction of the ridges of the first decorative portion and the inclination in the tire circumferential direction of the ridges of the second decorative portion are in the opposite direction from each other with respect to the tire radial direction.

5. The pneumatic tire according to claim 1, wherein markings formed of a plurality of ridges are provided on a surface of the information indicator portion.

6. The pneumatic tire according to claim 1, further comprising a third decorative portion provided on the tire side portion and configured such that at least a portion in the tire circumferential direction occupies the same location in the tire circumferential direction as the second decorative portion, the third decorative portion being located outward of the second decorative portion in the tire radial direction and arranged to be separated from the second decorative portion, the third decorative portion including ridges aligned in a plurality of rows, the ridges being oriented at an angle different from the angle of the ridges of the first decorative portion with respect to the tire radial direction.

7. The pneumatic tire according to claim 6, further comprising a fourth decorative portion provided on the tire side portion and configured such that at least a portion in the tire radial direction occupies the same location in the tire radial direction as the third decorative portion, the fourth decorative portion being located in the tire circumferential direction closer to the first decorative portion than the third decorative portion, located outward of the first decorative portion in the tire radial direction, and arranged to be separated from the first decorative portion and the third decorative portion, the fourth decorative portion including ridges aligned in a plurality of rows, the ridges being oriented at an angle different from the angle of the ridges of the first decorative portion with respect to the tire radial direction.

8. The pneumatic tire according to claim 2, wherein
the first decorative portion is configured such that all the ridges of the first decorative portion on a same position in the tire radial direction form a same angle with respect to the tire radial direction, and
the second decorative portion is configured such that all the ridges of the second decorative portion on a same position in the tire radial direction form a same angle with respect to the tire radial direction.

9. The pneumatic tire according to claim 8, wherein the inclination in the tire circumferential direction of the ridges of the first decorative portion and the inclination in the tire circumferential direction of the ridges of the second decorative portion are in the opposite direction from each other with respect to the tire radial direction.

10. The pneumatic tire according to claim 9, wherein markings formed of a plurality of ridges are provided on a surface of the information indicator portion.

11. The pneumatic tire according to claim 10, further comprising a third decorative portion provided on the tire side portion and configured such that at least a portion in the tire circumferential direction occupies the same location in the tire circumferential direction as the second decorative portion, the third decorative portion being located outward of the second decorative portion in the tire radial direction and arranged to be separated from the second decorative portion, the third decorative portion including ridges aligned in a plurality of rows, the ridges being oriented at an angle different from the angle of the ridges of the first decorative portion with respect to the tire radial direction.

12. The pneumatic tire according to claim 11, further comprising a fourth decorative portion provided on the tire side portion and configured such that at least a portion in the tire radial direction occupies the same location in the tire radial direction as the third decorative portion, the fourth decorative portion being located in the tire circumferential direction closer to the first decorative portion than the third decorative portion, located outward of the first decorative portion in the tire radial direction, and arranged to be separated from the first decorative portion and the third decorative portion, the fourth decorative portion including ridges aligned in a plurality of rows, the ridges being oriented at an angle different from the angle of the ridges of the first decorative portion with respect to the tire radial direction.
